(19) United States
(12) Patent Application Publication
(10) Pub. No.: US 2026/0145346 A1
(43) Pub. Date: May 28, 2026

(54) Energy Guide Chain with a Pull Rope Detector Arrangement

(71) Applicant: igus GmbH, Köln (DE)

(72) Inventor: Thilo-Alexander Jaeker, Sankt Augustin (DE)

(21) Appl. No.: 18/877,110

(22) PCT Filed: Jun. 19, 2023
(86) PCT No.: PCT/EP2023/066497

§ 371 Date: Dec. 19, 2024

(30) Foreign Application Priority Data
Jun. 21, 2022 (DE) 202022103458.3

(51) Int. Cl. B25J 19/00; F16G 13/16; F16G 13/18

(52) U.S. Cl. CPC B25J 19/0025; F16G 13/16; F16G 13/18

(57) ABSTRACT

The invention relates to an energy guide chain (4) with an arrangement for monitoring the energy guide chain including a detector (40) with the pull rope (22). The monitoring arrangement includes a flexible outer sheath (20) rigid in compression in a pull direction, in which at least one longitudinal portion of the pull rope (22) is guided. The outer sheath (20) with the longitudinal portion of the pull rope (22) extending therein are guided by the energy guide chain (4). According to at least one embodiment, the detector (40) is configured to identify relative motion of the pull rope (22) relative to the outer sheath (20).

The invention relates in general to the field of energy guide chains or dynamic line guides for guiding one or more lines, such as cables, hoses or the like, between two connection points at least one of which is mobile relative to the other.

The invention is not restricted to a particular design of energy guide chain or dynamic line guide. Energy guide chains typically have a plurality of links or segments connected to one another in the longitudinal direction of the chain, said links or segments are pivotable about at least one swivel axis or optionally a plurality of swivel axes.

Energy guide chains, in particular those which can be only incompletely protected against external effects due to their application, may be damaged during operation, for example by a foreign body, causing jamming. This may result in partial or complete rupture. Failure of the energy guide chain may occur even in the case of protected energy guide chains, for example due to excess wear, excessively high temperatures or other general conditions outside a nominal range, or simply by its service life being exceeded. In the worst case scenarios, a rupture may result in snapping of one or more of the guided lines, which may lead to failure of the machine or installation being supplied.

The invention therefore relates, in particular, to an energy guide chain with a monitoring arrangement for monitoring the energy guide chain, which can be used, in particular, to protect against snapping of the guided line or lines, and to a corresponding monitoring system. Furthermore, the invention also relates to a detector arrangement for monitoring an energy guide chain.

A generic arrangement for monitoring the energy guide chain comprising a detector and a pull rope, which runs in the longitudinal chain direction and interacts mechanically with the detector, in particular for detecting a rupture in the energy guide chain, has already been proposed by the applicant in WO 2015/118143A1. This system has been a commercial success, but has potential for various improvements. On the one hand, guidance of the pull rope in the chain, according to WO 2015/118143 A1 on the neutral axis of the energy guide chain, is only possible with elevated materials expenditure and installation effort. Furthermore, a relatively complex sensor system is needed in the detector, for example with an incremental transducer as displacement sensor, the evaluation of which has to some extent to be adapted to the application because of the different, application-dependent chain lengths. Furthermore, the solution provided by WO 2015/118143 A1 is not straightforwardly usable for other energy guide chains. For example, the solution from WO 2015/118143A1, in particular, cannot straightforwardly be applied in “robot chains” (energy guide chains for articulated-arm robots) with links which are three-dimensionally deflectable relative to one another, as proposed, for example, in WO 2004/093279A1 .

Further prior art relating to monitoring systems is likewise acknowledged in the introduction of WO 2015/118143A1, to which, for the sake of brevity, reference is made.

Starting from the above prior art, in particular from monitoring with a pull rope according to WO 2015/118143A1, it is a first object of the present invention to propose a solution which is more favorable or better suited to the widest range of energy guide chains and/or applications. In this respect, the solution is intended to be maximally robust and durable and/or in particular to enable use in energy guide chains for articulated-arm robots with links which are three-dimensionally deflectable relative to one another. Furthermore, the solution is preferably intended to enable simplification of the sensor system in the detector or of the detector.

The first-stated object is achieved with an energy guide chain with detector arrangement according to claim 1, and independently thereof with a detector arrangement according to claim 14. The dependent claims and secondary independent claims 16 and 18 reveal advantageous further developments.

The energy guide chain according to the invention has, in particular, an arrangement for monitoring the energy guide chain comprising a detector and a pull rope, which runs in the longitudinal direction of the chain and interacts mechanically with the detector, in particular for detecting a rupture in the energy guide chain.

The energy guide chain according to the invention is distinguished initially in that the arrangement has a flexible outer sheath rigid in compression in a pull direction, in which at least one longitudinal portion of the pull rope is guided, wherein the outer sheath is sufficiently rigid in compression or dimensionally stable in particular relative to a spring used for pretensioning and/or is sufficiently compression-resistant for use as a pull rope outer sheath. It is furthermore distinguished in that the outer sheath with the longitudinal portion of the pull rope extending therein is guided at least along a longitudinal portion to be monitored of the energy guide chain, in particular comprising a plurality of links or segments of the energy guide chain, by the energy guide chain, in particular within the energy guide chain. The invention is furthermore distinguished in that the detector, the outer sheath and the pull rope are arranged such that the detector is provided and set up to identify relative motion between the pull rope and the outer sheath, wherein the detector is, in particular, connected to this end with one end of the pull rope.

A core concept of the invention is that the pull rope is guided with at least one longitudinal portion according to the per se known Bowden cable principle or in the manner of a rope pull in an additional outer sheath provided expressly for the pull rope. The pull rope is not itself guided directly by the energy guide chain, but rather only indirectly by the outer sheath guided on or in the energy guide chain.

A Bowden cable consists substantially of an inner cable (core, pull rope, inner rope), which is placed in a flexible outer sheath (also Bowden cable sheath or rope sheath) which is sufficiently pressure-resistant in the pull direction. The outer sheath serves to guide the inner cable and as a steady for reinforcement relative to the tensile forces to be transmitted. The Bowden cable may thereby simply transmit tensile forces along any desired curved path (providing the curvature does not fall below a certain radius). This principle was identified according to the invention as being particularly advantageous for use of a detector with force-transmitting pull rope in the widest range of energy guide chains, in particular also in energy guide chains for articulated-arm robots with links deflectable three-dimensionally relative to one another.

The relatively simple measure according to the invention of an additional outer sheath or rope sheath for the pull rope, on the basis of the Bowden cable principle, offers a number of significant advantages. Firstly, the pull rope with the outer sheath may in principle be placed at any desired point of the accommodation space, in a similar manner to the lines to be guided and with the latter, in the energy guide chain, an arrangement on a neutral axis (which is not typically present in the case of three-dimensionally deflectable links) not being necessary since the pull rope is already adequately guided by the outer sheath or rope sheath. Furthermore, due to the outer sheath, pretensioning on the pull rope, which is not fundamentally dependent on chain length, but rather merely on the length of pull rope used, is more readily adjustable. In this way, the sensor systems can also be considerably simplified. No application-dependent path measurement and path evaluation is needed, in particular with regard to deflections of the pull rope arising during operation. The outer sheath or pull rope sheath additionally makes it possible, in a simplified manner, to monitor only a specific longitudinal portion of the energy guide chain. Installation over or monitoring of the total length of the energy guide chain is also possible and simplified. The detector arrangement with the outer sheath or rope sheath for the pull rope is additionally more robust with regard to external disruptive influences, for example movements of the lines within the energy guide chain.

The pull rope is durably flexible, in particular slack. The pull rope, in particular, exhibits low elongation, in particular it exhibits an elongation (engineering strain) under nominal working load, i.e., under a nominal tensile load corresponding to normal operation (not at rupture), of <3%, preferably <1%, based on the original length. Elongation in the longitudinal direction still remains in the linear elasticity range even under twice the working load. A low-elongation plastics rope, for example of Dyneema® fibers, may, for example, be used as the pull rope, or indeed a wire rope or a stranded wire, in particular a steel wire rope.

The term “pull rope” should predominantly be understood in the broadest sense and also, for example, encompasses non-stranded wires, cords or the like which exhibit sufficiently low elongation for the intended tensile force transmission, for example with engineering strain of <1% under nominal working load (for example nominal pretensioning of the pull rope by a tension spring against the rope sheath or outer sheath).

In an advantageous embodiment, the arrangement has at least one tension spring, with which the pull rope is pretensioned with pretensioning in the tensile force direction, in particular is pretensioned against the outer sheath.

The outer sheath or pull rope sheath is preferably secured separately and independently of the pull rope in the pull direction or in the longitudinal direction, for example fixedly to a connection point outside the energy guide chain or on one of the chain links of the energy guide chain.

A Bowden cable sheath is preferably used as the outer sheath. The internal diameter thereof is preferably larger, to provide play, in particular at least 1 mm larger than the external diameter of the inner cable or inner rope. A lubricant-free or maintenance-free Bowden cable sheath with suitable plastics inner coating, for example of Teflon, is particularly preferred.

Provision may preferably be made for the arrangement to have an actuating member at the end on the outer sheath, which member is displaceable relative to the pressure-resistant outer sheath in the longitudinal direction of the chain. The other end of the pull rope remote from the detector may be secured in a tensile stress-resistant manner to the actuating member, such that this end of the pull rope cannot be drawn into the outer sheath. Means known per se, for example, securing using clamping nipples or press nipples are sufficient for this purpose.

In one simply implemented embodiment, the actuating member is embodied as a type of end sleeve, which can be fixed with play onto the outer sheath and holds the pull rope in the pull direction, for example corresponding to an end piece of a Bowden cable arrangement.

Provision may be made for the outer sheath to be secured to a first fastening point in the longitudinal direction of the chain, in particular to a chain link in or on the energy guide chain or to one of the connection points outside the energy guide chain.

In this regard, the actuating member may be secured to a second fastening point in the longitudinal direction of the chain, in particular to a chain link in or on the energy guide chain or to the other connection point outside the energy guide chain.

The fastening points remote from one another for the outer sheath and the pull rope end or actuating member are in this case selected, in particular, such that the longitudinal portion to be monitored of the energy guide chain lies between two fastening points in the longitudinal direction of the chain.

Provision may preferably be made for the detector to have a detector housing, to which preferably one end of the outer sheath is attached, such that the detector housing forms a support for absorbing compressive force for this end of the outer sheath.

In particular, provision may advantageously furthermore be made for an indicator element connected to the one end of the pull rope to be mounted displaceably in the detector housing, in particular using a linear guide. Moreover, the detector housing may have an adjusting device, in particular with adjusting screw, for axial displacement of the outer sheath, in particular for the purpose of adjusting pretensioning against the outer sheath, which is generated by an extension spring or tension spring advantageously connected to the pull rope. A tension spring may furthermore be arranged on or in the detector housing. In this respect, the tension spring may act on the end of the pull rope which is connected to the detector, and/or on the indicator element.

In one particularly simple embodiment of the detector, provision may be made for the detector to have an indicator element connected to the one end of the pull rope, which the indicator element is displaceably mounted, and at least one proximity switch, in particular an inductive and/or capacitive proximity switch, which interacts with the indicator element to generate a signal which is dependent on the position of the indicator element or is indicative of this position. Conventional commercial proximity switches, in particular inductive and/or capacitive proximity switches, are very inexpensive compared with displacement sensors and, thanks to the Bowden cable principle, in particular in conjunction with spring pretensioning, may enable sufficiently precise identification or discernment of a rupture without precise position evaluation of the pull rope end being necessary. It is merely necessary to provide a suitable design of the indicator element, with sufficient tolerance with regard to false triggering, for example by an elongate hole in the pull direction in the indicator element. The indicator element is in this case displaced by the pull rope in the pull direction if a rupture occurs in the chain by which a broken-open chain end brings about a transverse load on the outer sheath.

Embodiments have proven particularly favorable in which the length of the outer sheath amounts to a multiple of the chain pitch and/or at least 10% of the chain length, in particular at least 25% of the chain length, and/or the outer sheath runs with at least a majority of its length along the energy guide chain, in particular within the energy guide chain; and/or the pull rope has a greater length than the outer sheath and/or is accommodated and guided with a majority of its length in the outer sheath.

The outer sheath may be embodied as an elongate, in particular a pull rope outer sheath (rope sheath), in particular for a Bowden cable. Tests have shown that an outer sheath which is pull-resistant with regard to typical tensile forces, in the manner of a rope pull, is not absolutely necessary, with another hose-like sheath, with lower tensile strength, possibly also being sufficient, for example a woven plastics hose or the like. In this regard, the outer sheath has only to exhibit sufficient tensile strength relative to the desired pretensioning to prevent undesired compression in the longitudinal direction. The outer sheath is preferably continuous, in particular closed circumferentially and lengthwise throughout its entire longitudinal extent. The outer sheath is a flexible tubular pull rope sheath, i.e., it forms a cavity or a lumen in which at least one longitudinal portion of the pull rope is guided, in particular in longitudinally displaceable manner.

The outer sheath may optionally also, as is typical of Bowden cables, comprise a tubular flat wire spiral or round wire spiral, preferably with inner lining tube of plastics, to avoid excessive friction on the pull rope, and/or with an outer jacket of plastics, in particular to protect the lines guided in the energy guide chain.

The outer sheath preferably has a small external diameter, preferably of <10 mm, in particular <7 mm, such that it takes up as little space usable for lines as possible in the receiving space or interior of the energy guide chain. A relatively thin pull rope is accordingly also preferred. The pull rope is embodied, in particular as a plastics rope or, steel wire rope, to exhibit low elongation and may preferably be selected with a diameter of <3 mm, in particular with a diameter of <2 mm. Suitable conventional commercial items sold by length are used for the outer sheath and the pull rope.

With regard to mounting the essential components of the detector arrangement, i.e., the detector, the outer sheath and the pull rope, provision is preferably made for the detector to be fastened to a connection point, in particular a stationary connection point, of the energy guide chain and for the outer sheath to have an end which is fixed relative to the detector, in particular an end secured to the detector or to a fastening point fixed relative to the detector, out of which end is guided the one end of the pull rope which is connected to the detector.

The construction according to the invention allows the outer sheath with the pull rope guided therein to be placed at least in places loose in the energy guide chain. This allows a considerable simplification in manufacture of the energy guide chain or installation of the detector arrangement on the energy guide chain.

The configuration according to the invention of the detector arrangement is suitable in particular for “robot chains” (energy guide chains for articulated-arm robots), i.e., energy guide chains with links which are three-dimensionally deflectable relative to one another. The construction of the energy guide chain may in this respect correspond, for example, to that of WO 2004/093279 A1 or that of EP 1492967B1. In this case, the energy guide chain typically has links which are pivotable in at least two directions, in particular three-dimensionally or in the manner of a ball joint, relative to one another. In general, articulated joints are here provided between each pair of links connected together in articulated manner, wherein the links in each case have mutually corresponding joint elements, preferably a joint body, in particular in the manner of a ball joint, and a joint body socket, in particular in the manner of a ball cup. In this case, each link has a receiving space open at the end and delimited, in particular, by circular arc-shaped guide elements radially on the outside, optionally surrounded in closed manner by guide elements which can be folded open or with an insertion opening which is delimited by bendable guide elements so lines can be inserted laterally. In the longitudinal direction of the chain, the links typically form at least one guide channel. The outer sheath according to the invention with the longitudinal portion of the pull rope extending therein may be arranged on the guide channel formed by the links, corresponding to the lines to be guided. Thanks to the outer sheath, the construction according to the invention is compatible with any desired energy guide chain course, including spatially free courses.

The configuration according to the invention of the detector arrangement is likewise suitable for conventional energy guide chains, as disclosed, for example, in WO 2015/118143A1, to which, for the sake of brevity, reference is made. In this case, the energy guide chain is typically displaceable in a displacement plane, for example a vertical plane, forming a first run, a second run and a deflection arc joining the runs. Such energy guide chains have links which are arranged one behind the other in the longitudinal direction of the chain and are pivotable relative to one another in each case about a predetermined swivel axis substantially perpendicular to the displacement plane, to form a deflection arc. The articulated joint may, for example, be implemented as a pin/receptacle revolute joint connection, wherein the swivel axes in each case lie perpendicular to the displacement plane and are parallel to one another.

Typically, the first run is connected with a moving end capable of relative motion and the second run is connected to a stationary connection point.

In such conventional energy guide chains, provision may in particular be made for the outer sheath to be arranged with the longitudinal portion of the pull rope extending therein in a longitudinal portion of the energy guide chain preferably at the moving end, wherein an actuatable end of the pull rope or the actuating member of the pull rope may, in particular, be fastened to a chain link within the energy guide chain or secured in the longitudinal direction of the chain. The invention is equally applicable for chains with a self-supporting upper run and for sliding chains, as disclosed in WO 2015/118143A1, i.e., for chains in which the first run can preferably slide or roll on the second run. In the case of a conventional energy guide chain, provision may be made for the longitudinal portion of the energy guide chain at the moving end to start from an end chain link at the moving end and/or to comprise preferably at least 10% of the chain length, in particular at least 25% of the chain length.

The invention also relates to an arrangement according to the invention for monitoring the energy guide chain taken alone with its essential components (without the energy guide chain). These comprise a detector, a pull rope, which is connected with one rope end to the detector and interacts mechanically with the detector, in particular for detecting a rupture in an energy guide chain to be monitored, and furthermore according to the invention a flexible outer sheath or pull rope sheath, in particular rigid in compression in a pull direction, in which at least one longitudinal portion of the pull rope is guided. The detector may here be configured in a particularly simple manner to identify relative motion between pull rope and outer sheath, for example with just a conventional commercial proximity switch, such as, for example, an inductive proximity switch which responds in the event of predefined excursion of the pull rope relative to the outer sheath, in particular in the pull direction.

The detector arrangement for monitoring the energy guide chain taken alone may in this case advantageously have any suitable combination of features of one or more of the above-described embodiments.

The invention also relates to use on a robot, in particular an industrial articulated-arm robot, and to such an (articulated-arm) robot comprising an energy guide chain with detector arrangement as proposed herein or described above, in particular with a three-dimensionally deflectable energy guide chain.

In this case, the articulated-arm robot may typically have a robot arm with a robot hand. In this case, a favorable arrangement for maximally complete monitoring of the energy guide chain provides for one end of the energy guide chain to be secured to a first connection point on the robot hand, wherein the end of the pull rope remote from the detector is secured fixedly to the first connection point on the robot hand, and for the other end of the energy guide chain to be secured to a second connection point on the robot arm, wherein the detector and the outer sheath are fastened fixedly to the second connection point on the robot arm. The connection points are in this case, in particular, selected such that the pull rope with outer sheath runs through the energy guide chain over virtually the entire or the entire length of the latter.

The invention further also relates to a monitoring system for protecting an energy guide chain against line snapping comprising an evaluation unit, wherein the system is distinguished by an energy guide chain or a detector arrangement according to one of the embodiments described herein. In this respect, the detector connected to the pull rope may, in particular, be connected for signaling to the evaluation unit, wherein the evaluation unit is configured to evaluate signals detected by the detector with regard to a possible rupture in the energy guide chain and/or wherein the evaluation unit preferably outputs an emergency stop signal and/or a maintenance signal in the case of an identified rupture.

Further details, advantages and features of the invention can be inferred from the description of an exemplary embodiment given below on the basis of the appended drawings, in which:

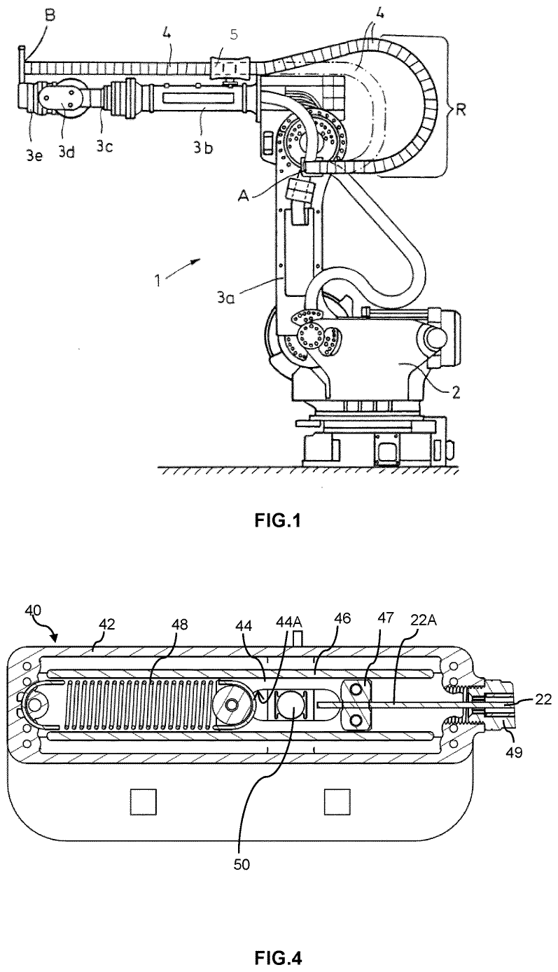

FIG. 1 is a schematic representation of an articulated-arm robot, showing the course or arrangement of the line guide (for hoses and/or cables) in an energy guide chain for supplying an application installation, not shown, on the robot hand;

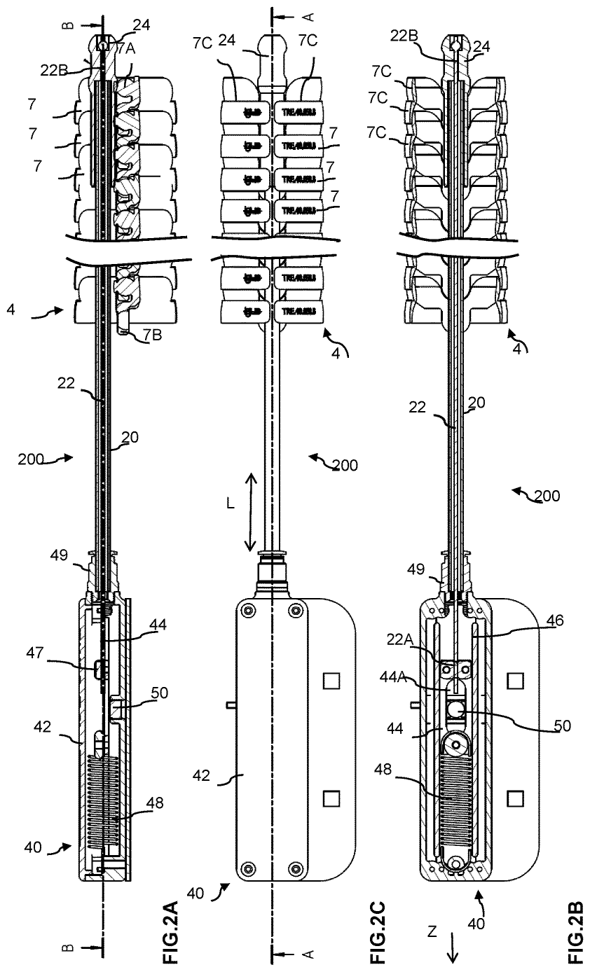

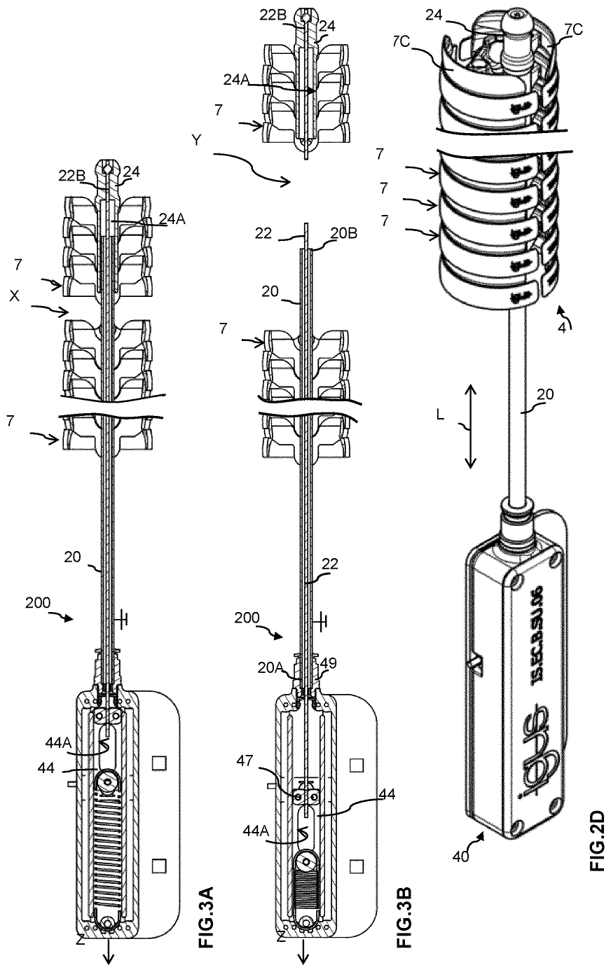

FIGS. 2A-2D: show a monitoring system according to the invention and an energy guide chain according to the invention with detector arrangement in vertical longitudinal section (FIG. 2A, along section line A-A of FIG. 2C), in plan view (FIG. 2C), in horizontal longitudinal section (FIG. 2B, along section line B-B of FIG. 2C), and in perspective view (FIG. 2D) in each case in the functional state of the energy guide chain, which in each case is shown only in part;

FIGS. 3A-3B: are schematic representations of the energy guide chain and of the detector in the event of a rupture in the energy guide chain (FIG. 3A) or snapping of the energy guide chain and the pull rope of the detector arrangement (FIG. 3B), in each case in sectional view corresponding FIG. 2B; and

FIG. 4: shows an enlarged horizontal longitudinal section (along section line B-B of FIG. 2A) through an exemplary embodiment according to the invention of the detector as such (in the nominal rest position in the case of a functional, undamaged energy guide chain) with which a pull rope guided in an outer sheath interacts, according to the invention.

The buckling-arm robot or articulated-arm robot 1 shown by way of example in FIG. 1 has a base 2 with swivel arm portions 3a, 3b, 3c, 3d, 3e fastened to the base, wherein the cables and hoses for an application (not shown) or an end effector (not shown), e.g., a gripper, a welding gun or the like, are guided along the swivel arm portions 3a, 3b, 3c, 3d, 3e from a lower connection point A to an upper connection point B, in an energy guide chain 4 for the robot hand with the end effector (not shown). Irrespective of robot type, the energy guide chain 4 is three-dimensionally deflectable at least in specific portions or movable with at least three degrees of freedom, such that the energy guide chain 4 can follow the movements of the joints of the articulated-arm robot 1.

In FIG. 1, the energy guide chain 4 is mounted fixedly at the upper connection point B and fastened rotatably, for example about its longitudinal axis, and is held on the swivel arm 3b in longitudinally displaceable manner by a bush 5. The energy guide chain 4 is likewise secured to the connection point A and runs as far as the upper connection point B.

An energy guide chain 4 which is particularly suitable for an articulated-arm robot 1 is known per se and described, for example, in WO 2004/093279A1, to which reference is made for the sake of brevity or whose teaching is in this respect incorporated herein by reference. Other energy guide chains, for example conventional energy guide chains or drag chains displaceable in a plane, may, for the purposes of the invention, advantageously be equipped with the proposed detector arrangement. One exemplary embodiment of the detector arrangement is illustrated in FIGS. 2-4 and will be described in greater detail hereinafter.

FIGS. 2A-2D show in a greater detail a sub-portion of a three-dimensionally deflectable energy guide chain 4 according to the principle of WO 2004/093279A1. The individual chain links 7 have a middle or central core with ball joint head 7A and corresponding ball joint socket 7B for three-dimensionally deflectable articulated connection, with high tensile strength in the longitudinal direction L, of the chain links 7, here for example in the manner of a ball joint connection. The chain links 7 each form a receiving space, open at the end, which is delimited by circular arc-shaped guide elements 7C radially on the outside, such that, in the longitudinal direction of the chain, the chain links 7 form at least one guide channel for lines (not shown) for the desired application, as for example in FIG. 1. The guide elements 7C are connected, here in one piece, in each case via a web with the central core.

A detector arrangement 200 according to the invention, cf. FIGS. 2A-2C, has a flexible outer sheath 20 which is rigid in compression in a pull direction and in which a majority of the length of a pull rope 22 is guided. The outer sheath 20 with longitudinal portion of the pull rope 22 guided displaceably therein is guided along a longitudinal portion C to be monitored, for example from the lower connection point A to the upper connection point B in FIG. 1. The longitudinal portion C comprises most or preferably all of the chain links 7 or segments of the energy guide chain 4. In FIGS. 2A-2D, the arrangement with outer sheath 20 and pull rope 22 is arranged in the manner of a Bowden cable and is guided within the energy guide chain 4. Depending on the energy guide chain, guidance laterally on the outside on the energy guide chain, for example on specific holders is also considered, as is proposed, for example, in WO 2016/146706A1.

FIG. 4 shows a preferred construction of a detector 40, which, together with the outer sheath 20 and the pull rope 22, constitutes a further component of the detector arrangement 200. The detector 40 is provided for identifying relative motion of the pull rope 22 relative to the outer sheath 20 and configured for that purpose.

The detector 40 has a detector housing 42, for example comprising two injection-molded shells, in which an elongate, plate-shaped indicator element 44 is guided by a linear guide 46 longitudinally displaceably in the longitudinal direction or in and contrary to the pull direction Z. The indicator element 44 is connected at one end region with the one first rope end 22A of the pull rope 22, for example using a clamping plate 47 or the like. At the other end region, the indicator element 44 is connected with a tension spring 48, for example a spiral spring, which is accommodated in the detector housing 42 and exerts predetermined pretensioning in pull direction Z on the end 22A of the pull rope 2 by way of the indicator element 44. The detector housing 42 has a base plate with fastening lug, for fastening for example to the robot arm, for example close to the lower connection point A as in FIG. 1.

A corresponding first end 20A of the outer sheath 20 is also mounted on the detector housing 42, wherein the detector housing 42 forms a support for absorbing compressive force for this end of the outer sheath 20.

The detector housing 42 of the detector 40 has an adjusting device for adjusting the pretensioning of the outer sheath 20 and/or of the pull rope 22. This has here, for example, an adjusting screw 49 which is embodied in the manner of a threaded end piece for cable pulls or Bowden cables and is adjustable relative to the detector housing 42 coaxial to the longitudinal direction in a thread on said housing. The adjusting screw 49 allows axial displacement of the first end 20A of the outer sheath 20 and thereby adjustment of the pretensioning acting on the outer sheath 20.

Furthermore, the detector arrangement 200 has at the end on the outer sheath an actuating member 24, which is displaceable relative to the pressure-resistant outer sheath 20 in the longitudinal direction L of the chain and at which a second rope end 22B of the pull rope, remote from the detector, is guided through and, for example, attached by press nipples or the like in tensile stress-resistant manner and held against detachment in the pull direction Z. The actuating member 24 is embodied as a hollow end sleeve, which can be placed with play onto the second, outer end 20B of the outer sheath 20 by way of a receptacle 24A and is displaceable relative thereto in the longitudinal direction L. The actuating member 24 is attached to a chain link 7 or a fastening point outside the energy guide chain 4. The actuating member 24 is, for example, fastened to the fastening point or at least held immobile thereon in the longitudinal direction, in particular against forces in the pull direction Z, for example at the upper connection point B (FIG. 1) of the articulated-arm robot 1. On the other hand, an end region of the outer sheath 20, close to the first end 20A thereof, is likewise fastened, for example to the or close to the lower connection point A (FIG. 1) of the articulated-arm robot 1, or is fastened fixedly to the detector housing, for example to the articulated-arm robot 1 or a chain link 7 secured there.

The detector 40 has a sensor element for interaction with the indicator element 44 actuated in the longitudinal direction L by the first rope end 22A of the pull rope 22 and adjustable thereby. In the example shown here, precisely one proximity switch 50 is provided as the (here sole) sensor element, for example an inexpensive inductive proximity switch. For this interaction, the indicator element 44 has an elongate hole 44A, such that the proximity switch 50 only produces an identification signal when a predetermined deflection or a predetermined excursion of the pull rope 22 arises due to relative motion of pull rope 22 and outer sheath 20.

Two exemplary fault cases detectable by way of example by the detector 40 are illustrated schematically in FIG. 3A and FIG. 3B. In the case of rupture of the energy guide chain 4, as shown schematically at X in FIG. 3A, a transverse load exerted by some of the chain links 7 on outer sheath 20 (loading effect not shown) brings about withdrawal of the second end 20B of the outer sheath 20 out of the actuating member 24 of the pull rope 22. In this way, the indicator element 44 moves into the position shown in FIG. 3A, being fully extended contrary to the pull direction Z, such that the elongate hole 44A is no longer positioned over the proximity switch 50 and this triggers a signal which indicates rupture of the energy guide chain 4. In the case of complete snapping of the energy guide chain 4 and/or of the outer sheath 20 with pull rope 22, snapping of which likewise represents a possible fault scenario due to detector failure, shown in FIG. 3B at Y, spring loading by the tension spring 48 draws the first end of the pull rope 22A or of the indicator 44 into the position shown in FIG. 3B, where it is drawn in fully in the pull direction Z. In this case too, the elongate hole 44A is no longer positioned over the proximity switch 50 and the latter thus triggers a signal, for example for maintenance purposes.

Construction of the detector 40 is considerably simplified in the above-described manner by using an outer sheath 20. Structurally very simple and inexpensive monitoring of a spatially deflectable energy guide chain 4 for robots is hereby enabled.

The pull rope 22 or the cable and the outer sheath 20 actuate the detector in the manner of a Bowden cable, wherein, however, no actual actuator is provided on the pull rope 22, but rather a load on the outer sheath 20 or a rupture is intended to be measurable. For this purpose, the pull rope 22 has a greater length than the outer sheath 20 and/or is accommodated and guided with a majority of its length in the outer sheath 20.

The length of the outer sheath 20 preferably amounts to a multiple of the chain pitch or longitudinal dimension of the chain links 7 and/or at least 10%, in particular at least 25% of the chain length of the energy guide chain 4. For reliable identification and/or simple installation, the outer sheath 20 is guided with at least a majority of its length inside the energy guide chain 4. The outer sheath 20 with the pull rope 22 guided therein may be placed at least in places loose in the energy guide chain.

Any suitable outer sheath 20 may be used, in particular, a pull rope outer sheath for a Bowden cable, which forms a tubular cavity in which at least one longitudinal portion of the pull rope 22 is guided. The outer sheath 20 may to this end comprise as a bearing element, a tubular and/or continuous flat wire spiral or round wire spiral. The outer sheath 20 preferably has an external diameter of <10 mm, in particular of <7 mm. The pull rope may be embodied as a plastics rope or steel wire rope, and is selected to exhibit minimum elongation, preferably with a diameter of <2 mm.

The invention is particularly advantageous for three-dimensionally deflectable energy guide chains, but is likewise applicable to conventional energy guide chains which travel in a plane, such as, for example, in WO 2015/118143A1. Thus, for example, replacement of a known device, e.g., a device as shown in FIGS. 1A-1B of WO 2015/118143 A1, may proceed using an arrangement at the moving end according to FIGS. 2A-2D. The arrangement proposed here for monitoring the energy guide chain, along with favorable construction, also enables reliable identification of fault cases.

As is moreover described in WO 2015/118143 A1 (FIGS. 1A-1B therein), the detector connected to the pull rope may be connected for signaling to a suitable evaluation unit (not shown here), which is configured to evaluate signals detected by the detector with regard to a possible rupture in the energy guide chain 4. In the case of an identified rupture, the evaluation unit may preferably output an emergency stop signal and/or a maintenance signal.

### LIST OF REFERENCE SIGNS

1 Robot
2 Base
3a,3b,3c,3d,3e Swivel arm portion
4 Energy guide chain
5 Bush
7 Chain link
7A Ball joint head
7B Ball joint socket
7C Guide element
20 Outer sheath
22 Pull rope
22A, 22B Rope end
24 Actuating member
40 Detector
42 Detector housing
44 Indicator element
44A Elongate hole
46 Linear guide
47 Clamping plate
48 Tension spring
49 Adjusting screw
50 Proximity switch
200 Detector arrangement
A, B Connection point
C Longitudinal portion
L Longitudinal direction of chain
X Rupture (energy guide chain)
Y Snap (pull rope)
Z Pull direction

1. An energy guide chain (4) for guiding at least one line between two connection points (A, B) with at least one connection point is mobile relative to the other connection point, the energy guide chain (4) comprising
a plurality of links (7) or segments connected to one another in the longitudinal direction of the chain, said links or segments being pivotable about at least one swivel axis, and
an arrangement for monitoring the energy guide chain comprising a detector (40), a pull rope (22), which runs in the longitudinal direction of the chain and interacts mechanically with the detector, and a flexible outer sheath (20) rigid in compression in a pull direction and in which at least one longitudinal portion of the pull rope (22) is guided,
wherein the outer sheath (20) with the longitudinal portion of the pull rope (22) extending therein is guided at least along a longitudinal portion to be monitored comprising the plurality of links (7) or segments of the energy guide chain (4), by the energy guide chain (4), and
the detector (40) is configured to identify relative motion of the pull rope (22) relative to the outer sheath (20) connected with a rope end (22A) of the pull rope (22).

2. The energy guide chain according to claim 1, wherein the arrangement has a tension spring (48), with which the pull rope (22) is pretensioned with pretensioning in the tensile force direction against the outer sheath.

3. The energy guide chain according to claim 1, wherein the outer sheath (20) is pressure resistant and the arrangement has an actuating member (24) at a first end on the outer sheath (20), which is displaceable relative to the outer sheath (20) in the longitudinal direction of the chain and to which a second end (22B) of the pull rope remote from the detector is secured in a tensile stress-resistant manner.

4. The energy guide chain according to claim 3, wherein the outer sheath (20) is secured to a first fastening point in the longitudinal direction of the chain, and the actuating member (24) is secured to a second fastening point in the longitudinal direction of the chain, wherein the first fastening point and the second fastening point are selected such that the longitudinal portion to be monitored of the energy guide chain (4) lies between the first fastening point and the second fastening point in the longitudinal direction of the chain.

5. The energy guide chain according to claim 2, wherein the detector (40) has
a detector housing (42), to which one end of the outer sheath (20) is attached, such that the detector housing (42) forms a support for absorbing compressive force for this end of the outer sheath;
wherein
an indicator element (44) connected to the end (22A) of the pull rope (22) that is mounted displaceably in the detector housing; and/or
the detector housing (42) has an adjusting device, for axial displacement of the outer sheath (20), and/or
the tension spring (48) is arranged on or in the detector housing (42) and acts on the end (22A) of the pull rope (22) and/or on the indicator element.

6. The energy guide chain according to one of preceding claims 1, wherein the detector has an indicator element (44) connected to the end (22A) of the pull rope, which the indicator element is displaceably mounted, and at least one proximity switch (50), which interacts with the indicator element (44) to generate a signal which is dependent on the position thereof.

7. The energy guide chain according to claim 1, wherein,
the length of the outer sheath (20) is a multiple of the chain pitch and/or at least 10% of the chain length; and/or
the outer sheath (20) runs with at least a majority of its length along the energy guide chain (4); and/or
the pull rope (22) has a greater length than the outer sheath (20) and/or is accommodated and guided with a majority of its length in the outer sheath (20).

8. The energy guide chain according to claim 1, wherein the outer sheath (20) is an elongate, pull rope outer sheath for a Bowden cable, which forms a tubular cavity in which at least one longitudinal portion of the pull rope is guided, wherein
the outer sheath (20) comprises a tubular and/or continuous flat wire spiral or a round wire spiral;
the outer sheath (20) has an external diameter of <10 mm; and/or
the pull rope (22) is a plastics rope or a steel wire rope, with low elongation.

9. The energy guide chain according to claim 4, wherein the detector (40) is fastened to the connection point (A) of the energy guide chain (4) and in that the outer sheath (20) has an end fixed relative to the detector (40), out of which end the rope end (22A) of the pull rope is guided.

10. The energy guide chain according to claim 1. wherein the outer sheath (20) with the pull rope (22) guided therein is placed at least in places loose in the energy guide chain.

11. The energy guide chain according to claim 1. wherein the energy guide chain (4) has links (7) which are pivotable in at least two directions relative to one another, wherein articulated joints (7A, 7B) are provided between each pair of links (7) connected together in articulated manner, wherein each link (7) forms a receiving space, open at the end, which is delimited by circular arc-shaped guide elements radially on the outside, such that in the longitudinal direction of the chain the links (7) form at least one guide channel, wherein the outer sheath (20) with the longitudinal portion of the pull rope extending therein is arranged in the guide channel formed by the links.

12. The energy guide chain according to claim 3, wherein the energy guide chain is displaceable in a displacement plane, forming a first run, a second run and a deflection arc joining the runs, wherein the energy guide chain has links which are arranged one behind the other in the longitudinal direction of the chain and are pivotable relative to one another in each case about a predetermined swivel axis substantially perpendicular to the displacement plane, to form a deflection arc, and wherein the first run is connected with a moving end capable of relative motion and the second run is connected to a stationary connection point, and in that the outer sheath (20) is arranged with the longitudinal portion of the pull rope (22) extending therein in a longitudinal portion of the energy guide chain the moving end, wherein the actuating member (24) of the pull rope (22) is fastened to a chain link within the energy guide chain or secured in the longitudinal direction of the chain.

13. The energy guide chain according to claim 12, wherein the longitudinal portion of the energy guide chain at the moving end starts from an end chain link at the moving end and/or comprises at least 10% of the chain length.

14. An arrangement for monitoring an energy guide chain, the arrangement comprising:
a detector (40)
a pull rope (22), which is connected by one rope end (22A) to the detector (40) and interacts mechanically with the detector for detecting a rupture in the energy guide chain (4); and
a flexible outer sheath (20) rigid in compression in a pull direction, in which at least one longitudinal portion of the pull rope (22) is guided, and
wherein the detector (40) is configured to identify relative motion between the pull rope and the outer sheath.

15. The arrangement according to claim 14, further comprising:
a tension spring (48), with which the pull rope (22) is pretensioned with pretensioning in the tensile force direction against the outer sheath; and
an actuating member (24) at a first end on the outer sheath (20), which is displaceable relative to the outer sheath (20) in the longitudinal direction of the chain and to which a second end (22B) of the pull rope remote from the detector is secured in a tensile stress-resistant manner.

16. An articulated-arm robot (1) comprising the energy guide chain with detector arrangement according to claim 11.

17. The articulated-arm robot (1) according to claim 16, further comprising a robot arm (3a-3e) with a robot hand, wherein one end of the energy guide chain is secured to the first connection point (B) on the robot hand, wherein an end (22B) of the pull rope (22) remote from the detector (40) is secured fixedly to the first connection point on the robot hand, and in that a second end of the energy guide chain (4) is secured to the second connection point (A) on the robot arm, wherein the detector (40) and the outer sheath (22) are fastened fixedly to the second connection point (A) on the robot arm (3a-3e).

18. A monitoring system for protecting an energy guide chain against line snapping, the monitoring system comprising an evaluation unit and the energy guide chain according to claim 1, wherein the detector connected to the pull rope is connected for signaling to the evaluation unit and the evaluation unit is configured to evaluate signals detected by the detector with regard to a possible rupture in the energy guide chain, wherein the evaluation unit outputs an emergency stop signal and/or a maintenance signal in the case of an identified rupture.

19. The energy guide chain according to claim 7, wherein the length of the outer sheath (20) at least 25% of the length of the energy guide chain.

20. The energy guide chain according to claim 8, wherein the outer sheath has an external diameter of less than 7 millimeters.
